(19) United States
(12) Patent Application Publication
(10) Pub. No.: US 2006/0292036 A1
(43) Pub. Date: Dec. 28, 2006

(54) Fluid specimen testing device

(75) Inventors: Martin Gould, Mullica Hill, NJ (US); Robert Bernstine, Chesapeake City, MD (US); Robert J. Smalley, Woodbury, NJ (US); Jacqueline A. Gale, Kempshott (GB)

Correspondence Address: Edmund M. Jaskiewicz, Suite 400, 1730 M Street NW, Washington, DC, 20036, US

(73) Assignee: American Bio Medica Corporation

(21) Appl. No.: 11/443,050

(22) Filed: May 31, 2006

Related U.S. Application Data
(63) Continuation-in-part of application No. 11/252,599, filed on Oct. 19, 2005.
Application No. 11/252,599 is a continuation-in-part of application No. 11/167,227, filed on Jun. 28, 2005.

(51) Int. Cl. G01N 31/22

(52) U.S. Cl. 422/58

(57) ABSTRACT

A saliva sample testing device has a base housing upon which is mounted an upper housing. The base housing has a drawer structure in which are formed reaction wells for receiving fluid specimens. The drawer may be slidable or pivotable out of this base housing to provide access to the reaction wells. In a modification the reaction wells are formed in the top surface of the base housing and the upper housing is tiltable upon or detached from the base housing to provide access to the reaction wells.

### CROSS REFERENCE TO RELATED APPLICATIONS

The present application is a continuation-in-part of the U.S. patent application Ser. No. 11/252,599 filed Oct. 19,2005, now pending, which is a continuation-in-part of U.S. patent application Ser. No. 11/167,227 filed Jun. 28, 2005, now pending and incorporated by reference.

### BACKGROUND OF THE INVENTION

1. Field of the Invention

The present invention relates to diagnostic testing of saliva samples for drugs of abuse, more particularly, to a device and process which permits the saliva sample to be treated and incubated for a pre-determined period of time prior to being introduced to an immunoassay test strip.

2. Description of Related Art

The increased availability and use of drugs of abuse by the general population has caused employers, governmental agencies, sports groups and other organizations to utilize drug screening both as a condition of employment and in order to maintain safety in the work place. Screening tests for the detection of drugs of abuse range in complexity from simple immunoassay tests to very complex analytical procedures. Over the years the speed and specificity of immunoassays have made them one of the most accepted methods for screening for drugs of abuse in body fluids. Typical drug screening tests are performed for the purpose of quickly identifying on a qualitative basis, the presence of drugs in a body fluid which may be urine or saliva. A complete analysis of the sample may then be carried out in a laboratory only if the preliminary screening results are positive. More and more such drug screenings are taking place on site or at the work place and are generally carried out by testing personnel who are generally not technically trained, such as laboratory technicians. It is thus important that the drug screening procedure is simple but yet reliable. Further, the test apparatus must be such so as to enable the testing personnel to-avoid all contact with the fluid specimen which is being tested.

While blood and urine samples have long been the primary fluids used for testing for disease as well as for evidence of substance abuse, there is increasing interest in testing of salivary specimens. Some advantages in testing saliva are that it is relatively easy to obtain a saliva sample and that a saliva sample cannot be adulterated. Also, testing of saliva gives a result in real time within a span of several hours as compared to urine which gives a test result after-the-fact.

However, the collection and analysis of saliva for diagnostic purposes is complicated by the relatively high viscosity of the fluid and the small volumes of salivary fluid secreted.

In particular, saliva contains mucins which are a family of large, heavily glycosylated proteins which account for many of the properties of saliva. However, the mucins also act to disrupt the lateral flow necessary to achieve a rapid and accurate test result and greatly restrict both the time it takes for a sample to travel through the immunoassay strip as well as the amount of the target compound in the sample which can travel up the strip and thus be determined by the immunoassay strip.

Because of the problems caused by mucins, certain testing systems had recommended long and elaborate procedures for removing mucins prior to testing the sample. It was considered to be necessary to pre-treat a sample such as saliva with a diluent or other reagent which is capable of breaking down the interferants in a sample, e.g., mucins in saliva, so that these interferants do not restrict the capillary flow of the sample through the test strip, which will result in a rapid test of target compounds in a more accurate manner than heretofore possible.

If the sample requires pre-treatment with specific reagents to dilute or denature interferants, modify analyte structure, or release analyte from binders, such treatments are generally performed outside the confines of the test device.

After the sample has been collected, extracted from the collecter and mixed with a buffer inside of a small container or vial, the sample is then dispensed into a reaction well in which there may be a second reagent for testing with an immunoassay test strip.

It is apparent, however, that some advantages would be derived from a self-contained saliva sample test device that allows control over the test sample during pre-treatment and testing and is simple to use so that more accurate test results may be obtained.

U.S. Pat. No. 6,634,243—Wickstead is a prior art device which has an inadequate and ineffective provision for control of the test sample. Other relevant prior art includes U.S. Pat. No. 6,267,722—Anderson et al, U.S. Pat. 6,214,629—Freitag et al and U.S. Pat. No. 5,630,986—Charlton et al.

U.S. Pat. Nos. 6,464,939, 6,468,474 and 6,489,172, each issued to Bachand et al, show saliva testing devices in which the test fluid which has been expressed from a collecting swab is flowed down a channel or groove onto a lateral flow reagent test strip encased in a platform.

### SUMMARY OF THE INVENTION

It is, therefore, the principal object of the present invention to provide a novel and improved saliva test device and a method of carrying out a saliva test.

It is another object of the present invention to provide such a saliva test device that allows the test sample to be treated and incubated prior to being introduced to the test strip.

It is a further object of the present invention to provide a saliva test device which is particularly adapted to receive a sample which has been collected, extracted and treated with a reagent.

It is an additional object of the present invention to provide such a saliva test device that provides ready access to a reaction well for a test sample which is then contacted by a test strip.

The objects of the present invention are achieved and the disadvantages of the prior art are eliminated by the saliva test device according to the present invention which has a base housing upon which is mounted an upper housing. Within the base housing is a means for defining preferably two reaction wells to receive fluid specimens to be tested. The upper housing is a hollow tubular structure and is mounted in such a position so that its interior communicates with the reaction wells. Either one of the upper housing or the reaction well means may be movable with respect to the other for the purpose of providing access to a reaction well so as to enable a fluid specimen to be dispensed therein. A test strip is movably supported in the upper housing such that the test strip can be placed into a reaction well to contact a fluid test specimen therein.

The reaction well means comprises a drawer which may be slidable or pivotable to a position outside of the base housing to permit access to a reaction well. The drawer may be rectangular in shape to conform to the shape of the base housing. A front or an end wall surface of the base housing may have an opening through which the drawer is slidable. In a modification, a corner of the drawer is pivotably mounted at an opening in a front face of the rectangular base housing.

Within the upper housing there is a movably mounted support member upon which one or more test strip may be mounted. A manually operated trigger is attached to the strip support member and protrudes outwardly of the upper housing. The trigger can be pushed downwardly to place a test strip into a reaction well. The upper housing also has an opening through which the result portion of the test strip is exposed such that a test result can be viewed through the opening.

In another modification, access to the reaction well in the base housing can be gained by moving the upper housing with respect to the base housing. The upper housing may be pivotably mounted along a top edge of the base housing so as to be tiltable to uncover the reaction well.

The upper housing may be removable from the base housing and secured in position by a snap-fit closure lock. Further, the upper housing may be pivotable through a 90° angle at a pivot point between two reaction wells in the base housing so that both wells are uncovered.

A process for testing a saliva specimen with the testing device according to the present invention may comprise inserting the sponge end of a collector into the mouth of the person to be tested. The inside of the mouth and tongue are actively swabbed until the sponge becomes fully saturated. The collector is removed from the mouth and the oral fluid is collected from the sponge end. The collected oral fluid, together with a buffer agent, is then placed into a collection chamber which may be a container or vial and shaken to mix the oral fluid and buffer. The resulting mixture is then dispensed into a reaction well of the test device into which may have been previously placed a second reagent which is preferably a binder such as a colloidal gold-antibody complex or an antigen. The second reagent may be in the form of a dry dot or a pellet. After a period of incubation of the test mixture with the second reagent, a test strip is moved into the reaction well so that the sample receiving end of the test strip contacts the fluid specimen within the reaction well. The test result is then subsequently viewed on the test result portion of the test strip.

### BRIEF DESCRIPTION OF THE DRAWINGS

Other objects and advantages of the present invention will be apparent upon reference to the accompanying descriptions when taken in conjunction with the following drawings, which are exemplary, wherein:

FIG. 1 is a perspective view of the test device according to the present invention viewed from the rear and showing the sliding reaction well drawer in the open position;

FIG. 2 is a sectional view taken along the line II-II in FIG. 1 to show the base housing and reaction well drawer in the “closed” position together with a portion of the upper housing;

FIG. 3 is a perspective view similar to that of FIG. 1 viewing the test device from the front and showing the reaction drawer in the front face of the base housing;

FIG. 4 is a perspective view of the test device viewed from the front and with the upper housing removed to show the movable test strip holders;

FIG. 5 is a perspective view seen from the front of a modification of the test device in which the reaction drawer is pivotally mounted and is shown in its “closed” position;

FIG. 6 is a perspective view similar to that of FIG. 5 but showing the pivotable reaction drawer in its “open” position;

FIG. 7 is a perspective view of the testing device of FIG. 5 but viewed from the rear and showing the reaction drawer in the “open” position;

FIG. 8 is a perspective view seen from the front of another modification of the test device;

FIG. 9 is a perspective view seen from the front of the test device shown in FIG. 8 but with the upper housing being pivoted to a position to provide access to the reaction wells in the bottom housing;

FIG. 10 is a perspective view seen from the front of a further modification of the test device in which the upper housing is snapped into its upright position on the bottom housing;

FIG. 11 is a vertical sectional view taken along the line XI-XI of FIG. 10 showing the upper housing separated from the bottom housing;

FIG. 12 is a perspective view seen from the front of the bottom housing of the test device shown in FIG. 10 from which the upper housing has been removed to provide access to the reaction wells.

### DETAILED DESCRIPTION OF THE INVENTION

Proceeding next to the drawings wherein like reference symbols indicate the same parts throughout the various views, a specific embodiment and modifications of the present invention will be described in detail.

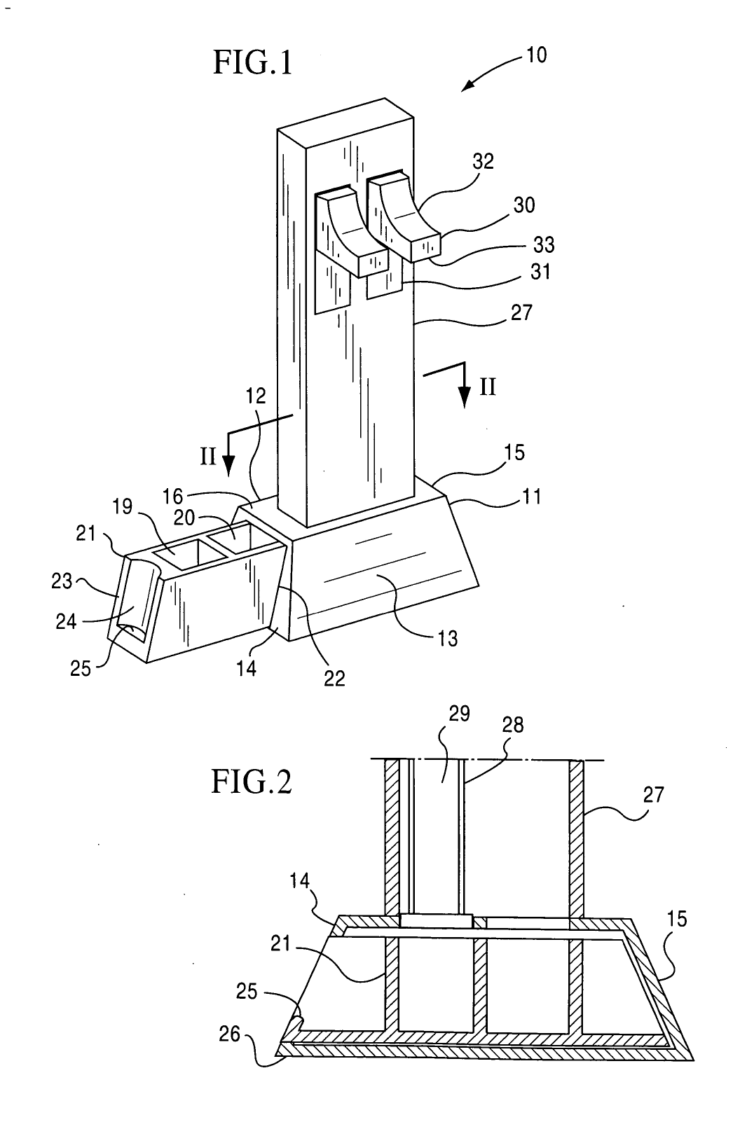

As may be seen in FIG. 1, a saliva sample testing device according to the present invention is indicated generally at 10 and comprises a base housing 11 which may be molded from a plastic material and having a front face 12, a rear face 13 and end faces 14 and 15 defining a rectangular horizontal cross-section. The base housing also has a top surface 16 in which are formed openings 17 and 18. to provide access to reaction wells 19 and 20 below formed in a sliding drawer 21. In this embodiment, the drawer 21 slides outwardly of the base housing through an opening 22 in the end face 14 of the base housing to an “open” position as shown in FIG. 1 in which access is provided to both reaction wells. The drawer has an end face 23 in which is formed a depression 24. At the bottom of depression 24 there is an upwardly extending lip 25 which functions as a finger grip to slide the drawer outwardsly from its “closed” position as shown in FIG. 2 to the position shown in FIG. 1. The drawer 21 slides upon a rectangular bottom surface 26 of the base housing from which the front and rear faces 12 and 13 and end faces 14 and 15 are upstanding. As an alternative, the drawer 21 may be mounted on a horizontal slide arrangement as known in the art.

An upper housing 27 is mounted on the top surface 16 of the base housing 10 and has a hollow or tubular construction with a rectangular cross-section. The hollow interior of the upper housing 27 encloses the openings 17 and 18 in the top surface 16 of the base housing to provide communication between the interior of the upper housing and the reaction wells 19 and 20 in the reaction drawer 21.

Two vertically extending test strip holders 28 are slidably mounted within the upper housing 27 on, for example, a vertical groove or trackway not shown in the drawings. A lateral flow immuno-assay test strip 29 is detachably mounted on each of the holders 28. Such a test strip is known in the art and generally has a backing member upon which are attached a porous sample receiving membrane and an analyte detection or test membrane having reaction zones therein which provide a visible detection or result signal.

Each strip holder has a laterally extending trigger 30 thereon on a side of the holder opposite from the side on which the test strip is attached. The trigger 30 protrudes outwardly of the upper housing through vertically extending slots 31. Each trigger has a curved upper surface 32 upon which a finger of the testing person is placed to move the strip holder and strip downwardly into a reaction well. The downward movement of a strip holder is limited by an underside 33 of the trigger contacting a bottom end of a slot 31.

On a front vertical face 34 of the upper housing there are a pair of slotted openings 35 aligned with the test strips on the holders and corresponding with the result section of each test strip so that test results can be viewed through these openings.

Each of the strip holders 28 is retained in the upper most position, as seen in FIG. 1, by a small detent or catch mechanism which can be readily overcome when a manual force is applied onto the upper surface 32 of a trigger to move the test strip downwardly.

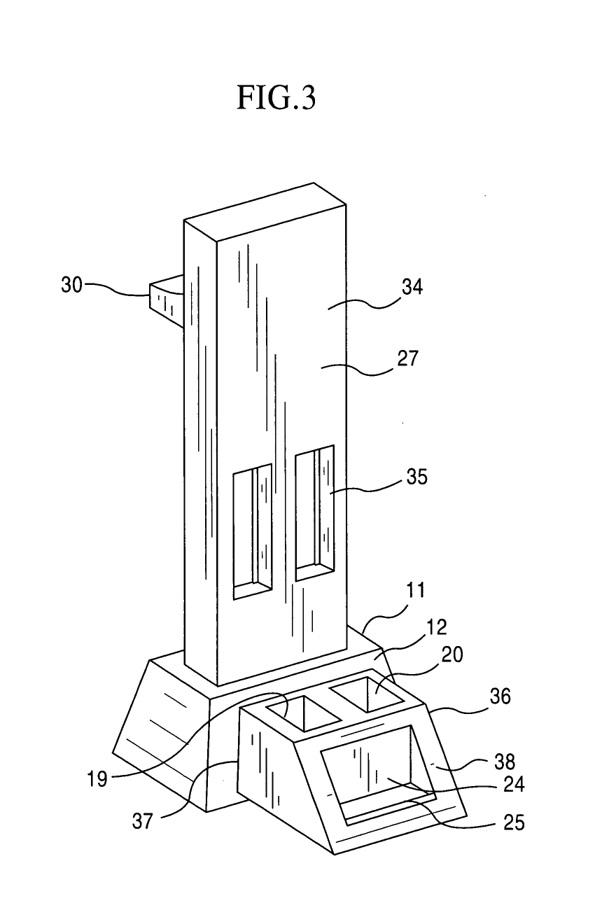

A modification of the test device shown in FIG. 3 discloses a reaction drawer 36 having reaction wells 19 and 20 and being slidable within an opening 37 in the front face 12 of the base housing. The drawer 36 has a front face 38 in which is formed the depression 24 and lip grip 25. Otherwise, the reaction drawer 36 is similar in form and function to the reaction drawer 21 described above.

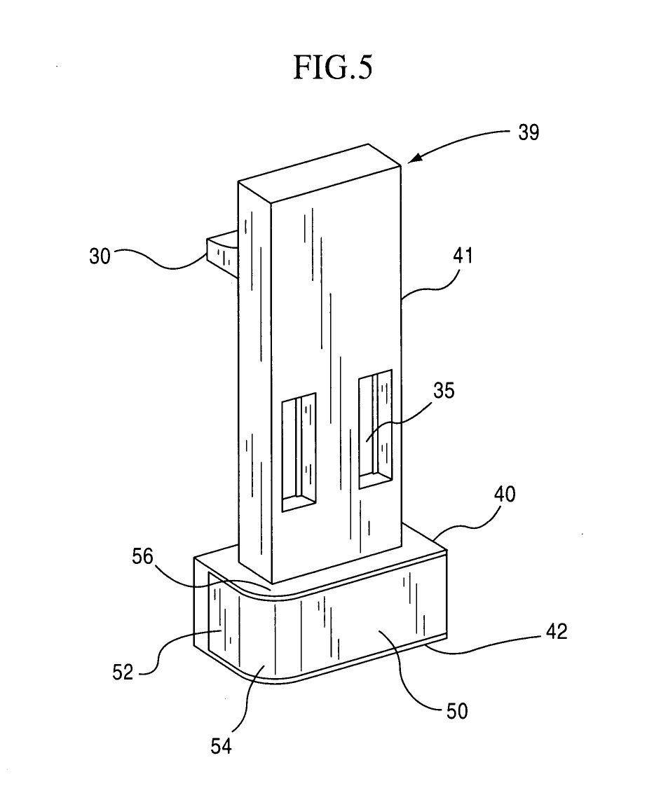

A modified testing device having a pivotably mounted reaction drawer in the base housing is shown at 39 in FIGS. 5-7 and comprises a base housing 40 and an upper housing 41. The base housing has a rectangular base or bottom surface 42 from which are vertically up-standing an end wall 43 and a rear wall 44 which are connected at a vertical corner 45. A top surface 46 is attached to top edges of the end wall 43 and rear wall 44 as may be seen in FIG. 7.

A reaction drawer 47 also having reaction wells 48 and 49 is substantially rectangularly shaped to correspond with the configuration of bottom surface 42 and to fit within the base member 40 as seen in FIGS. 5-7. The drawer 47 has a front wall 50 and a rear wall 51 which are interconnected by end walls 52 and 53. The intersection of front wall 50 and end wall 52 may form a curved or rounded corner 54 as shown in FIG. 5. Similarly, the intersection of rear wall 51 and end wall 53 may also be rounded as shown at 55 such that the rounded corners are diagonally opposed from each other.

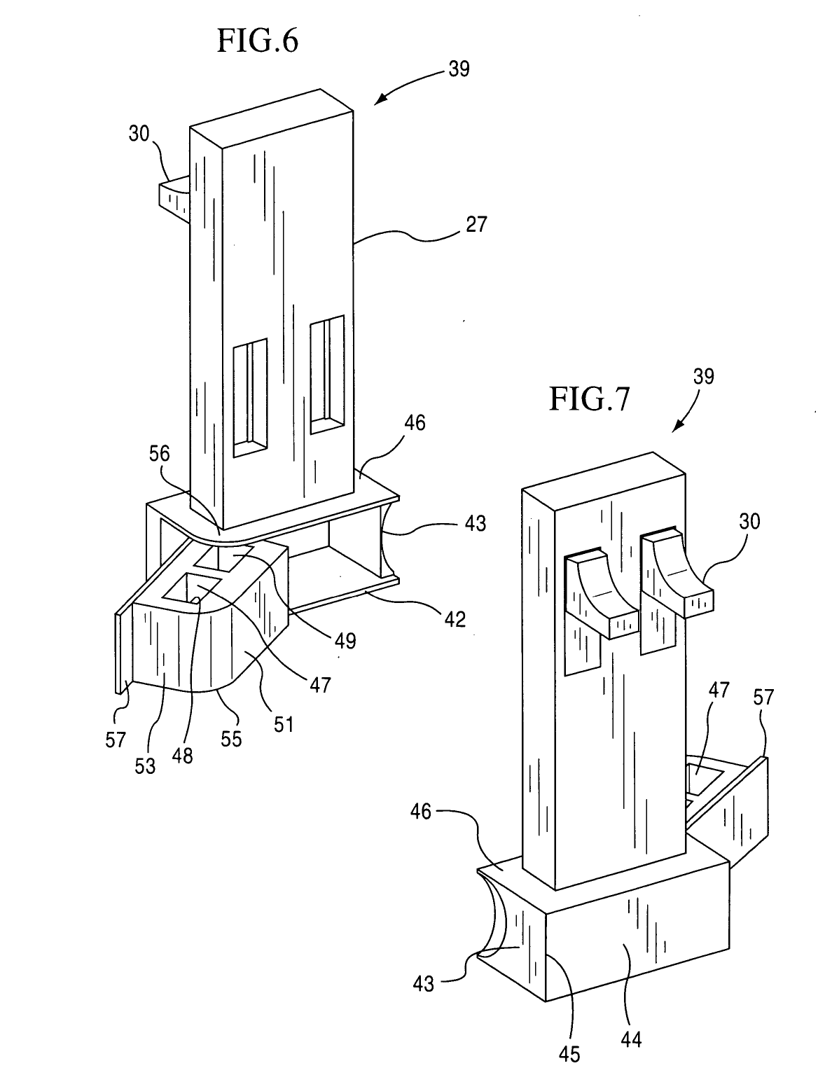

The drawer 47 is pivotably mounted in the base housing 40 between the top wall 46 and bottom surface 42 at a pivot point or connection 56 near the front curved corner 54 as seen in FIGS. 5 and 6.

The end wall 43 of the base housing is positioned inwardly of the ends of the top and bottom surfaces 46 and 42 as seen in FIG. 6 and the front wall 50 of the drawer has an end portion 57 which extends beyond the base housing end wall 43 to provide a handle or finger grip to facilitate pivoting of the drawer into the position shown in FIGS. 6 and 7 to provide access to the reaction wells 48 and 49 therein.

Mounted on the top surface 46 of the base housing 40 is the upper housing 27 which has been described above and which functions in the same manner.

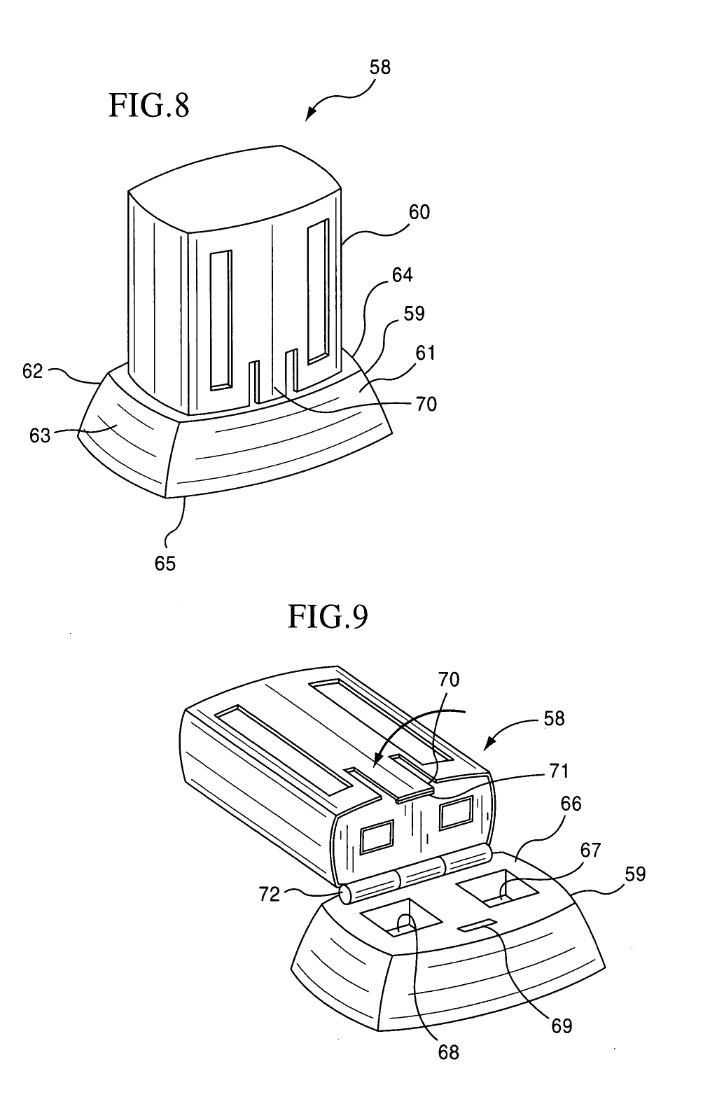

Another modification to provide access to the reaction wells comprises tilting the upper housing on the base as seen in testing device 58 shown in FIGS. 8 and 9. Similar to the previously discribed testing devices, the modification 58 has a base housing 59 and an upper housing 60. Lower housing has a front face 61, a rear face 62 and end faces 63 and 64 upstanding from a substantially rectangular bottom 65. There is a top surface 66 in which are former reaction wells 67 and 68 in the form of depressions and a latch opening 69.

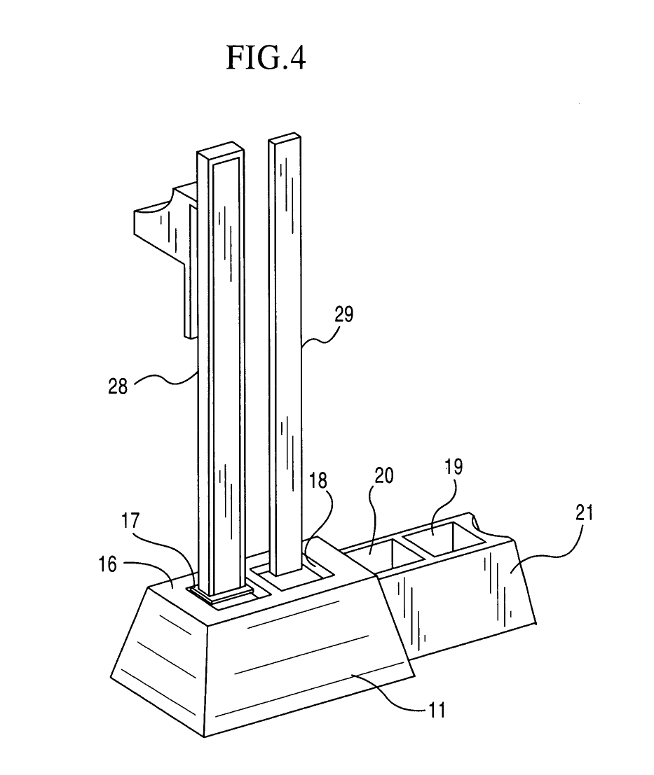

The upper housing 60 consists of thesame components as does upper housing 27 described in FIGS. 1-4 and functions in the same manner. Upper housing further has a latch 70 having a lip or catch 71 on its lower end and positioned to be inserted into the opening 69 when the upper housing is in the “closed” or upright position as shown in FIG. 8. The latch 70 is sufficiently resilient such that it can be depressed inwardly by the tester's finger to release the lip 71 from engagement with the underside of top surface 66.

The upper housing 60 is pivotally connected along an edge of the bottom housing by a hinge connection 72 as shown in FIG. 9. The upper housing 60 can be flipped or pivoted from its “closed” position in FIG. 8 to the “open” position seen in FIG. 9 to provide access to the reaction wells 67 and 68 for dispensing a sample solution therein.

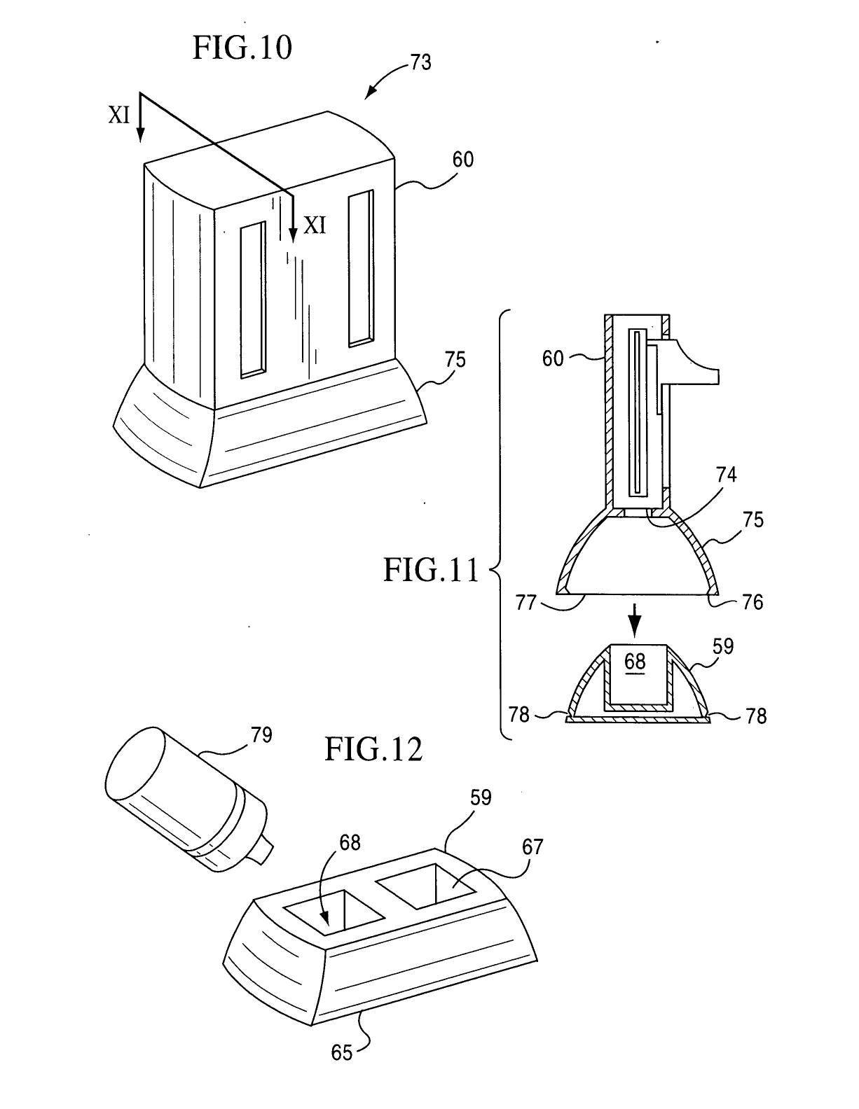

In FIGS. 10-12 there is shown a further modification 73 in which the upper housing is detachably mounted on the base housing and is separated from the base housing to provide access to the reaction wells. The testing device 73 also comprises a base housing 59 and an upper housing 60 as previously shown in FIGS. 8 and 9. The upper housing 60 further has an open bottom end 74 from which extends an open ended casing 75 shaped to conform to the outer surfaces of the base housing 59 so as to fit closely therein as shown in FIGS. 10 and 11. There is an inwardly extending lip 76 on at least portions of the casing open on bottom end 77. The lip 76 snaps into a correspondingly shaped groove 78 around the bottom edges of the front, rear and end faces 61-64 of the base housing 59. Detaching or removing the upper housing 60 from the base housing 59 permits access to reaction wells 67 and 68 so that a sample solution can be dispensed from a vial or container 79 as shown in FIG. 12.

In order to use the testing device, a sample of saliva is collected with a swab, extracted from the swab and mixed with a buffer inside of a vial which is capable of accurate and controlled dispensation. The upper housing of the testing device is then moved with respect to the bottom housing to provide access to the reaction wells in the top surface of the bottom housing. This movement may comprise a pivoting of the upper housing on the bottom housing or actual separation or removal of the upper housing from the bottom housing. Modifications of the testing device provide for a sliding or pivoting outwardly drawer structure within the base housing in which the reaction wells are formed.

The sample is then dispensed from the mixing vial into one or both reaction wells. The drawer structure is then closed into the bottom housing or, in modifications, the upper housing is returned to its upright position on top of the bottom housing. The sample is then mixed with a second reagent which has been previously placed or assembled in the reaction wells and the resulting test mixture is allowed to react with the second reagent for a predetermined period of time. That is, the test mixture is incubated for about 2-3 minutes.

After completion of the incubation period, the trigger 30 is manually depressed to lower the test strip into contact with the test mixture in a reaction well. Any reactions on the test strip may be observed through the viewing window 35.in the upper housing.

Thus it can be seen that the present invention discloses a saliva testing device which provides a novel and improved structure and process forcontacting a saliva fluid specimen with a lateral flow immunoassay test strip and reading the subsequent test results. The invention provides a simplified and effective structure which facilitates precise contacting of the saliva test sample with a test strip.

It will be understood that this invention is susceptible to modification in order to adapt it to different usages and conditions, and accordingly, it is desired to comprehend such modifications within this invention as may fall within the scope of the appended claims.

1. A fluid specimen testing device comprising a base housing,
means in said base housing for defining at least one reaction well therein to receive a fluid specimen,
said reaction well means being movable from a first position within said base housing to a second position outside of said base housing to provide access to said reaction well,
an upper housing mounted on said base housing and communicating with said reaction well means in said first position,
and means within said upper housing for supporting a test strip and movable within said upper housing to position a said test strip into a said reaction well to contact a specimen therein to initiate a test of said fluid specimen.

2. A fluid specimen testing device as claimed in claim 1 wherein
said reaction well means comprises a drawer which is pivotable between said first and second positions.

3. A fluid specimen testing device as claimed in claim 1 wherein
said reaction well means comprises a drawer which is pivotable between said first and second positions.

4. A fluid specimen testing device as claimed in claim 1 wherein
said test strip supporting means comprises a manually operable trigger protruding outwardly on a vertical face of said upper housing such that actuation of said trigger will move said strip support means.

5. A fluid specimen testing device as claimed in claim 4 wherein
there is at least one opening in another side face of said upper housing to expose a result portion of a said test strip such that a test result can be viewed through said opening.

6. A fluid specimen testing device as claimed in claim 2 wherein
said base housing has a substantially rectangular shaped bottom surface and four side faces upstanding therefrom.
one of said side faces has an opening therein and said drawer being slidable therethrough between said first and second positions.

7. A fluid specimen testing device as claimed in claim 2 wherein
said base housing has a substantially rectangular shaped bottom surface and two side faces upstanding therefrom and intersecting to form a first vertically extending corner, said drawer being rectangular and shaped to be accommodated within said base housing so as to define two further side faces thereof,
said drawer being pivotably mounted within said base housing.

8. A fluid specimen testing device as claimed in claim 7 wherein said two further side faces intersect to form a second vertical corner diagonal from said first vertical corner,
said drawer being pivotably mounted at said second vertical corner.

9. A fluid specimen testing device comprising
a base housing,
means in said base housing for defining at least one reaction well therein to receive a fluid specimen,
an upper housing mounted on said base housing in a first position and communicating with said reaction well means
one of said upper housing and said reaction well means being movable into a position to provide access to said reaction well to enable a fluid specimen to be dispensed therein,
and means within said upper housing for supporting a test strip and movable within said upper housing to position a test strip into a said reaction well to contact a fluid specimen therein to initiate a test of the fluid specimen therein.

10. A fluid specimen testing device as claimed in claim 9 wherein
said upper housing is pivotally mounted on said base housing.

11. A fluid specimen testing device as claimed in claim 10 wherein
said base housing has a substantially rectangular shaped bottom and a correspondingly shaped top surface with four vertical side surfaces interconnecting said bottom and top,
said reaction well means being positioned in said top surface of said base housing.

12. A fluid specimen testing device as claimed in claim 11 wherein
said upper housing is pivotally mounted on an edge defined by one of said side surfaces and said top surface so as to be tiltable to a second position.

13. A fluid specimen testing device as claimed in claim 9 wherein
said upper housing is removable from said base housing to a second position.

14. A fluid specimen testing device as claimed in claim 13 wherein
said upper housing is retained on said base housing in the first position by a snap fit.

15. A fluid specimen testing device as claimed in claim 13 wherein
said upper housing has a bottom end resting upon said base top surface in a first position,
an open ended casing extending from said bottom end of said upper housing and shaped to conform to the outer shape of said base housing so as to fit closely thereon.

16. A fluid specimen testing device as claimed in claim 15 and further comprising means on said casing for defining a snap-fit with said base housing,

17. A fluid specimen testing device as claimed in claim 16 wherein
said snap fit means comprises an inwardly extending lip on at least a portion of the casing open end to snap into a groove on the bottom portion of said base housing.

18. A process for testing an oral fluid specimen comprising the steps of
collecting a fluid specimen from the mouth of a person to be tested and mixing the fluid specimen with a buffer agent,
positioning a second reagent within a reaction well formed in the top surface of a base housing of a fluid testing device,
supporting a test strip in an upper housing mounted on the top surface of the base housing and in communication with the reaction well,
moving one of the upper housing or the top surface of the base housing into a position to provide access to the reaction well and dispensing the mixture of fluid specimen and buffer agent into the reaction well to form a test sample,
and moving the test strip into the reaction well to contact the test sample therein to initiate a test of the fluid specimen.
